(19) United States
(12) Patent Application Publication
(10) Pub. No.: US 2002/0069682 A1
(43) Pub. Date: Jun. 13, 2002

(54) Torque resistant security casing for a padlock

(76) Inventors: Ming Liang Shiao, Anaheim Hills, CA (US); Frank Minnella, Fountain Valley, CA (US)

Correspondence Address: David L. Bell. Esq., 2214-A Gates Ave., Redondo Beach, CA, 90278, US

(21) Appl. No.: 09/734,491

(22) Filed: Dec. 11, 2000

Related U.S. Application Data
(60) Provisional application No. 60/216,930, filed on Jul. 8, 2000.

(51) Int. Cl. E05B 67/38

(52) U.S. Cl. 70/56

(57) ABSTRACT

A hard shell unibody padlock case designed for a secure padlock, such as is used in the vending machine industry, means to provide resistance to torquing moment, with best mode contemplated including a slip ring designed to fit over the outside wall of the padlock casing, a breakable connection between said slip ring and said unibody padlock case, and grooves on the inside of the casing running parallel to the front and back of the casing and a concurrent groove running on the inside of said slip ring such that the connecting device is seated within the grooves. The preferred method for said means is to use a groove on the outside wall of the lock case, with a screw affixed to the slip ring and into the groove of the lock case such as to be slotted in to the groove. Said screw of sufficient strength to prevent the removal of the outer casing by force, while being weak enough to break into two or more pieces with the application of torque force sufficient to break the lock, shackles or the hasp. After the connection between the slip ring and the casing is broken, the slip ring rotates freely around the side of the casing. Said slip ring is designed such as to slide onto the padlock casing from the back without being able to move off of the padlock casing from the front. Said slip ring is designed such that it can only be applied or removed to the lock casing from the back of the casing. Means is also provided to provide a more secure fastening assembly to securely affix the shackle head housing to said unibody case in a manner which provides resistance to vandalism by drilling. The preferred embodiment of said means is to provide an assembly which comprises a ball bearing at the point of initial contact with a drill bit, with a roll pin aligned after said ball bearing and a set screw aligned after said roll pin.

### REFERENCE TO RELATED APPLICATIONS

This application is a perfection of a Provisional Application filed on Jul. 8, 2000 and having the stamp number: jc 541 U.S. PTO 60/216930

### FEDERALLY SPONSORED RESEARCH

Not Applicable

### REFERENCE TO MICROFICHE INDEX

Not Applicable

### BACKGROUND OF THE INVENTION

a) Field of Invention

070/055; 70/56—Padlock Case

The present invention relates generally to a protective case enclosing a keyed lock with a shackle, and more particularly to a security lock designed to prevent theft and vandalism to, among others, outdoor vending machines by providing resistance to bolt cutters cutting off the shackle, to breaking the shackle housing by drilling and to torque moment twisting off the hasps and/or breaking the lock in that manner.

b) Related Art

Although padlocks are generally used to provide some measure of security, they have not generally been an effective deterrent in outdoor areas prone to vandalism or in areas requinng higher security against break-ins. In most applications, a common padlock is vulnerable to cutting tools whereby the shackle is cut and the lock effectively broken. Additionally, traditional padlocks are susceptible to tampering by tools designed to fit into the padlock or by drills designed to break the lock mechanism.

A development towards protecting the shackle of a padlock, thereby making it more secure, was U.S. Pat. No. 3,835675, to Lippisch. This padlock extended the wall portion to cover a portion of the shackle. However, this padlock was still left the shackles partially exposed. The American Lock Company then marketed a padlock and a hard fixed casing around same to provide a more secure lock by completely covering the shackle when the lock was in a locked position. Said padlock currently being marketed as an American Lock Company Series 2000 lock. This lock offered little extra deterrence as one could apply twisting or torque motion which would ultimately either break the shackle or break the hasps. Thus, some method was needed to provide a way to prevent the application of torque to such a padlock. The invention being claimed herein is an improvement over the American Lock Company lock by solving the torque problem. The American Lock was also susceptible to breaking the housing securing the upper portion of the shackle when said shackle was in a locked position. The invention claimed herein further addresses that problem and is an additional improvement on prior art.

### BRIEF SUMMARY OF THE INVENTION

A hard, unibody casing for a padlock, and rigidly affixed to same, was designed by American Lock Company so as to provide greater security against theft by making it harder to break the lock, vis-a-vis cutting the shackles of the lock. The lock was sold primarily to, and used primarily by, the vending machine industry. A long standing problem with the American Lock design was that one could apply torque, through a pipe wrench or other similar instrument, and either break the padlock, the hasp or the shackles. This was because the design of the padlock called for the casing to be rigidly affixed to the padlock. Thus, said lock was only marginally effective in preventing one from breaking the lock's shackle or hasp and therefore did not serve as an effective deterrent to thieves, vandals, etc.

This long standing problem has been solved by securing the casing to the padlock in such a manner that the connection between the padlock and the outer casing is broken with the application of sufficient torque. The outer casing is a slip ring which slides onto the unibody case from the rear and is prevented from sliding past the front of the unibody casing. The slip ring is semi-rigidly affixed to the unibody case by means of a connection, such as a screw, which secures the connection from the slip ring into a groove in the unibody lock case. Thereafter, if torque is applied to the outer casing (the slip ring), the connection is broken and the outer casing simply spins around the padlock, negating any attempt to apply torque to the lock. The hard casing and the outer casing are designed in such a manner that the combination of the two continue to provide lock protection while still being resistant to torque.

An improvement over the original design includes a circular, hardened metal casing band attached to the padlock m such a manner that the connection between the outer casing (the slip ring) and the padlock casing will break with the application of sufficient torque, but will thereafter continue to secure the padlock while being resistant to further torque force.

A firther improvement to the design of the American Lock lock consists of an assembly securing the housing which holds the upper portion of the shackle when in a locked position. Said assembly makes said housing further resistant to entry by drilling into the screws holding said shackle housing.

Upon introduction into the market place, the lock has received immediate and enthusiastic acceptance and has proven itself to be superior to other locks addressing the same problems.

### BRIEF DESCRIPTION OF THE DRAWINGS

The drawings provided with this application show the side and bottom elevation of the slip ring surrounding the padlock case and the rear and bottom elevation of the padlock case. This invention is better understood when taken in conjunction with the drawings herein.

FIG. 1. Shows the front elevation of a unibody, circular padlock case (1), with an outer circle around the circumference of the padlock case, indicating the position of the slip ring (2) when the invention is fully assembled. At the top of the slip ring is a means (3) for semi-rigidly affixing the slip ring (2) onto the case (1). Shown in dashed lines is the area (4) housing the key lock within said unibody casing (1). Also shown in dashed lines is the position of a ledge visible from the rear elevation.

FIG. 2. Shows the rear elevation of said circular, unibody padlock case (1) with the slip ring (2) affixed to said pad lock case by means (3). On the lower ⅓ of the elevation is a horizontal line, indicating a small ledge extending outward from the rear of the case. Below and to the left of the line is a screw hole. Directly above the line is a cut out (6) which exposes and allows the single bar shackle (5) to connect to a hasp. The solid vertical line within the cut out indicates said single bar vertical shackle. Above the cut out are two small holes which form means (8) to allow resistance by drilling through the fasteners securing the shackle housing for the upper portion of the shackle when said shackle is in a locked position. At the top of said slip ring is means (3) to semi-rigidly affix said slip ring to said lock case. Preferred embodiment is a small screw set through said slip ring (1) and into grooves (7) which are in both said unibody case (1) and slip ring (2).

FIG. 3. Shows a side elevation of the slip ring (2) as affixed to the padlock case (1). To the left and within the outline of the assembled lock is a vertical column in dashed lines, indicating the location of grooves (7) within both said slip ring and said lock case. At the top of said box is a heavier line indicating means (3) to semi-rigidly affix said slip ring (2) to case (1). To the lower right of that is another rectangle in dashed lines indicating the location of the lock housing (4). To the upper right of means (7) is a rectangle in dashed lines showing the housing (8) to secure the head of the shackle when said shackle is in a locked position.

FIG. 4. Shows the bottom elevation of the slip ring (2) as it is attached to the padlock case means groove (7) working in conjunction with means (3) to semi-rigidly affix said slip ring to said lock case.

FIG. 5. Shows a rear perspective of the unibody case (1), showing a ledge extending from the back of said housing towards the viewer, the cut out (6) to expose the single shackle, means (3) at the top of the unibody case to affix the slip ring to said case, and means to affix the shackle head housing unit (8) in such a manner as to resist tampering by drilling.

FIG. 6. Shows the slip ring (2) sliding onto the unibody lock case (1) from the rear.

FIG. 7. Shows means to make the shackle head housing (8) resistant to tampering from drilling. Preferred means include the a fastening assembly, consisting of a ball bearing, roll pin and set screw, which affixes to shackle head housing (8) to the unibody lock case (1).

FIG. 8. Shows the bottom elevation of the unibody padlock case, as represented in manufacturing drawings, with groove (7) clearly indicated and means (9) to prevent the slip ring from extending beyond the front of the unibody case.

FIG. 9. Shows the side elevation of the slip ring, as represented in manufacturing drawings.

FIG. 10. Shows the bottom elevation of the slip ring, as represented in manufacturing drawings.

FIG. 11. Shows the side elevation of slip ring (2) as shown in the manufacturer's drawings.

### DESCRIPTION OF THE PREFERRED EMBODIMENT

The invention described in this specification utilizes certain principals and/or concepts as are set forth in the claims appended to this specification. Those skilled in the locksmithing arts will realize that these principals and/or concepts are capable of being expressed in a variety of embodiments different from the exact embodiment, herein depicted for illustrative purposes, without departing from the spirit or scope of this invention. For these reasons, the invention is to be construed in light of the claims and not to be construed as being limited to the illustrative embodiments.

The invention is an improvement over an existing lock. The existing lock was part of a continuing effort to ensure the security of the object to be protected, through the use of a padlock. Initially, the shackle of the padlock was partially covered, to prevent the shackle from being cut. Because the shackle was only partially covered, the shackle was also partially exposed. Thus, the initial device provided only a small amount of additional security over existing technology. An improvement was made wherein the entire lock and shackle was enclosed in a circular, unibody casing. Said casing caused the shackle to be covered when the lock was in use, thus preventing access to the protected object via cutting the shackle. However, this design, while being the best technology available for many years, still provided only marginal deterrence as it left the lock/hasp combination vulnerable to attack by torquing motion.

The improvement being claimed herein is an improvement over the original unibody lock case and solves the problem of vulnerability to torque moment. The best mode contemplated is the attachment of a slip ring around the unibody case, with said slip ring attached to the unibody case by a small screw which is positioned such that it is seated in grooves in both the outside of the unibody case and the inside of the slip ring. An additional improvement in the design makes the lock less resistant attack by drilling out the housing screw assembly which affixes the shackle head housing to the unibody lock case. The best mode contemplated is by securing said housing with a screw assembly which includes a ball bearing positioned at the point which would constitute the initial contact point between the screw assembly and the drill bit, with a roller pin aligned behind the ball bearing and a set screw aligned behind the roller pin.

In testing in high crime areas, the invention claimed herein proved to be the only lock which did not succumb to vandalism and/or attack. The improvements claimed in this invention consist of a method of making a lock casing resistant to torque moment and a method to make the shackle head housing assembly resist to attack vis-a-vis a drill.

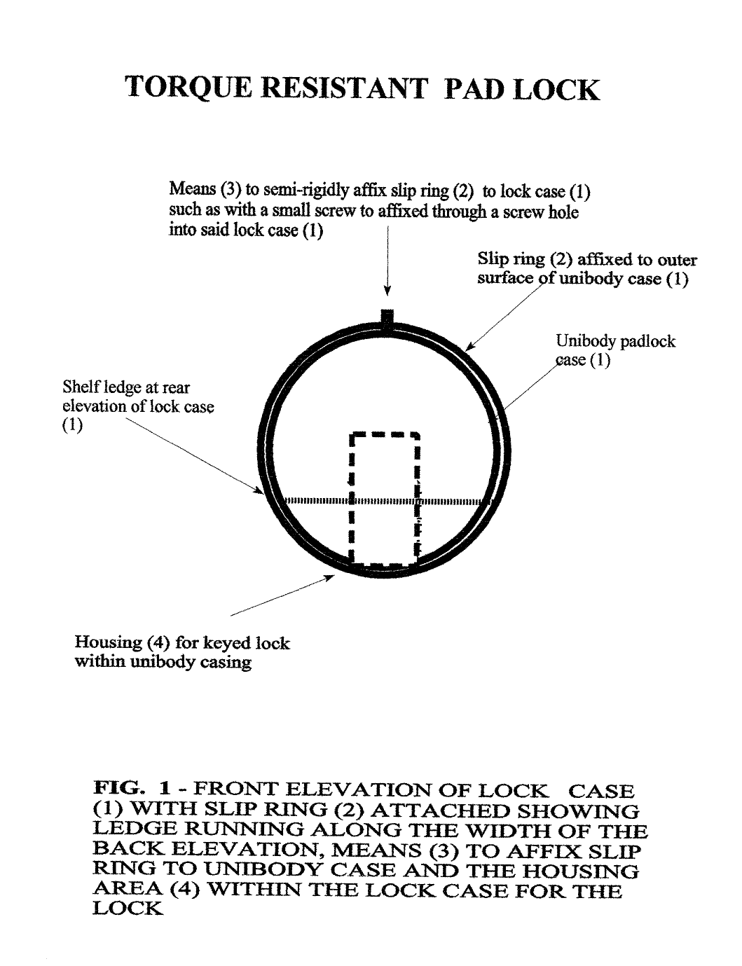

FIG. 1 shows the rear/back elevation of a unibody padlock casing with a cut-out in the upper ½ of the casing to allow a single I-shaped shackle to project upwards from the lock in the lower ½ of the casing and into a housing in the upper ½ of the casing. The casing surrounds and encloses the lock, which is rigidly affixed to the padlock case.

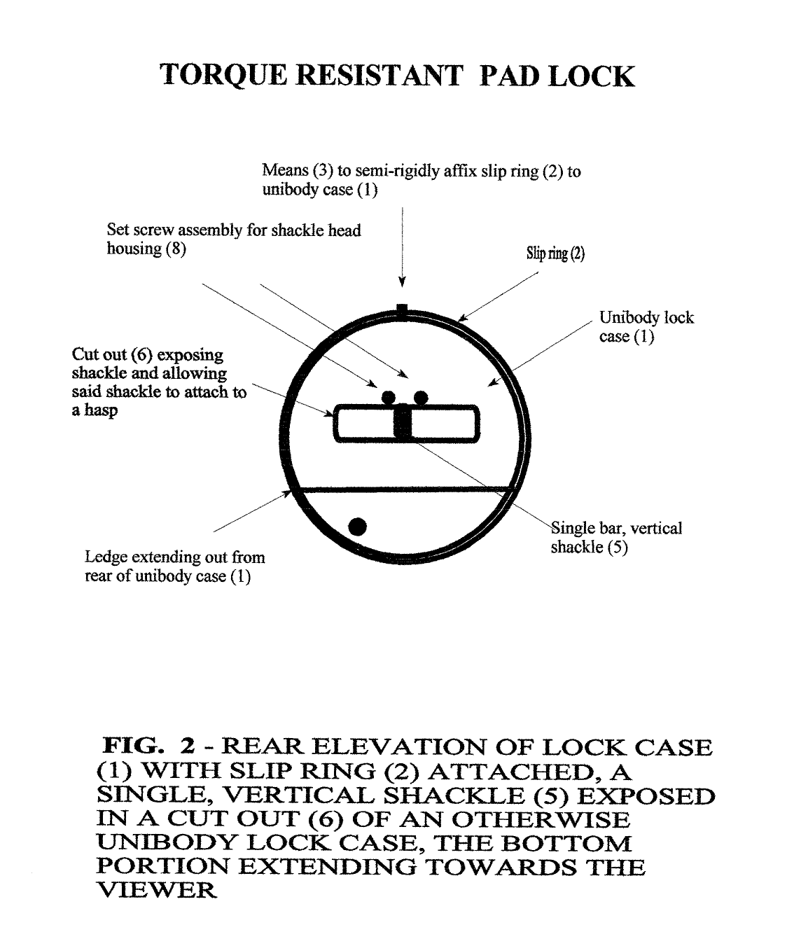

FIG. 2 shows the bottom elevation of the padlock case with means (4) for preventing the lateral movement of the slip ring by affixing a screw or other means through the slip ring and into the groove (4) of the padlock case, means for preventing the slip ring from sliding out from the front of the padlock case by means of a built-up portion of the padlock housing.

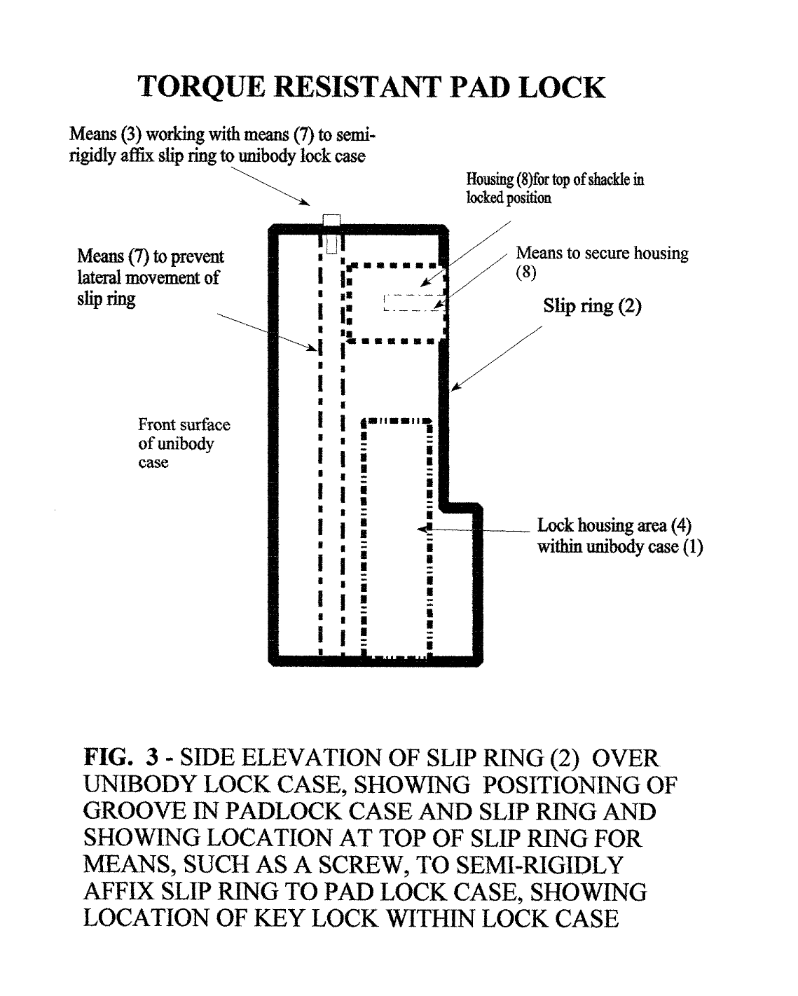

FIG. 3 shows the preferred means of providing torque resistance to the padlock case (1) means (1) a slip ring attached by means (3) a screw or some other semi-rigid device passing through the slip ring and in to the groove (4) on the padlock casing itself

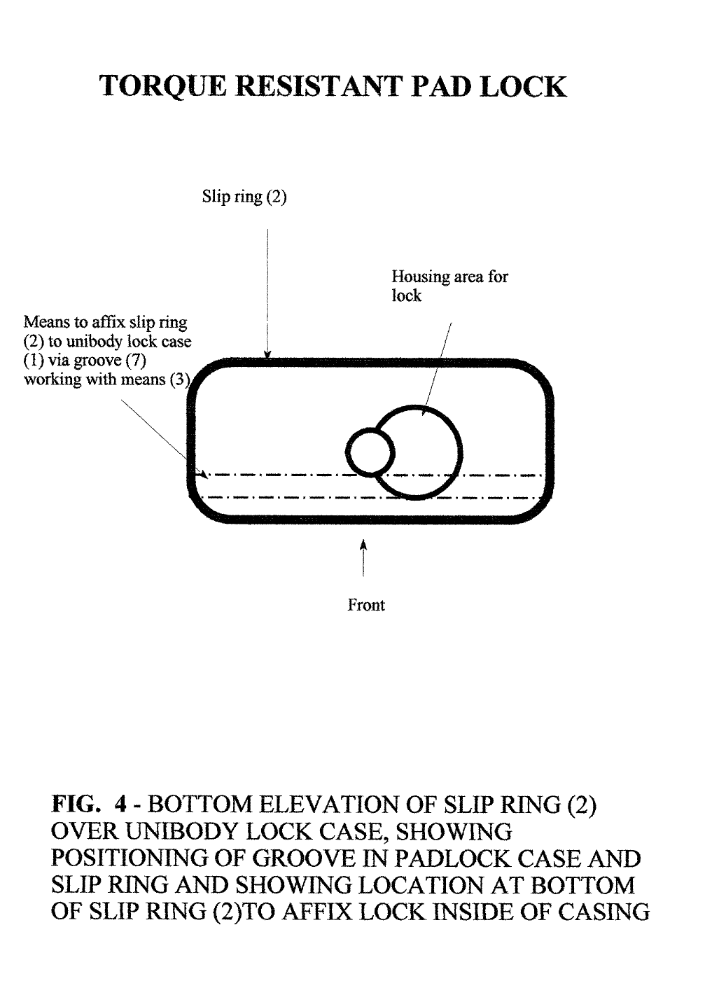

FIG. 4 shows the bottom elevation of the slip ring with a cut-out for the key lock and means (2) for preventing the slip ring from sliding off the front of the padlock casing.

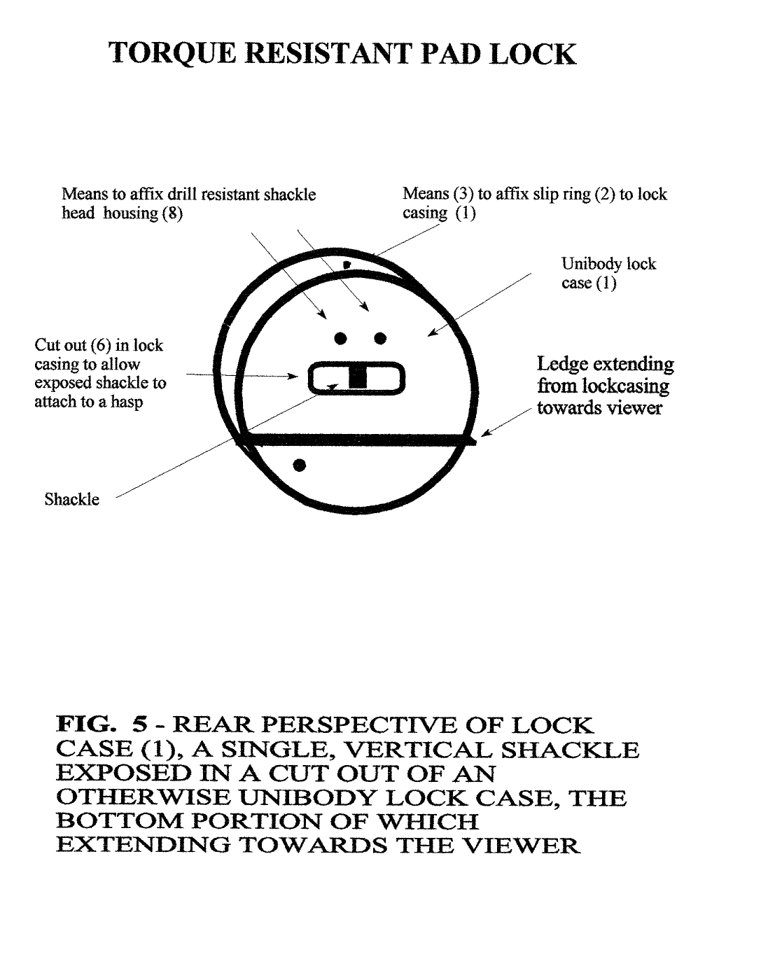

FIG. 5 shows a rear perspective of the unibody case (1), showing a ledge extending from the back of said housing towards the viewer, the cut out (6) to expose the single shackle, means (3) at the top of the unibody case to affix the slip ring to said case, and means to affix the shackle head housing unit (8) in such a manner as to resist tampering by drilling.

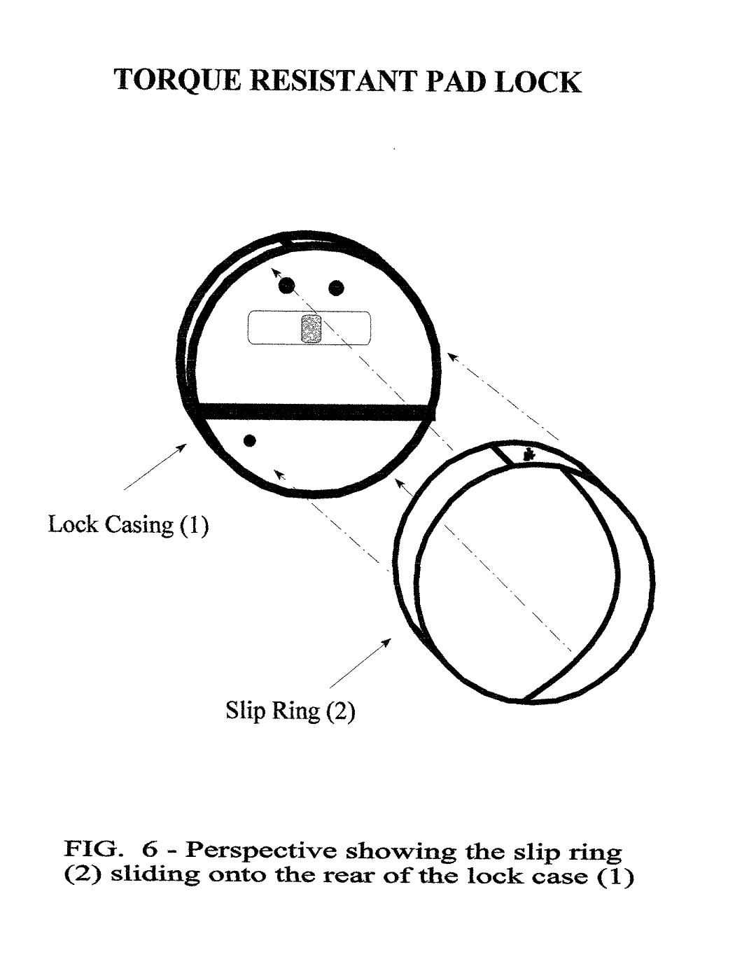

FIG. 6 shows the slip ring (2) sliding onto the unibody lock case (1) from the rear.

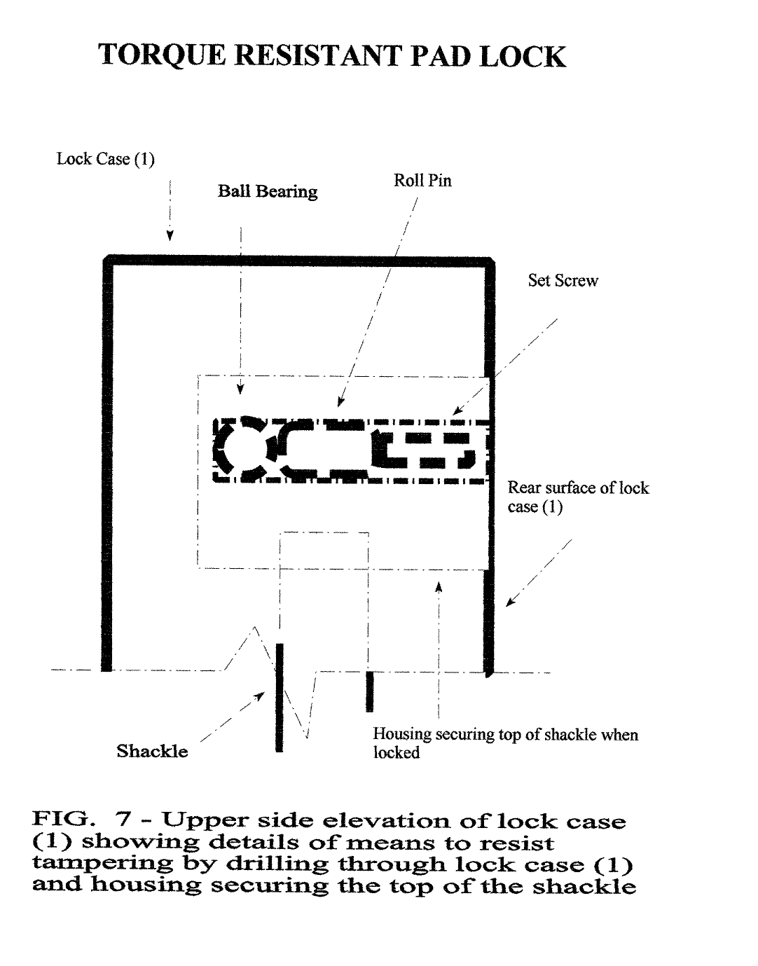

FIG. 7 shows means to make the shackle head housing (8) resistant to tampering from drilling. Preferred means include the a fastening assembly, consisting of a ball bearing, roll pin and set screw, which affixes to shackle head housing (8) to the unibody lock case (1).

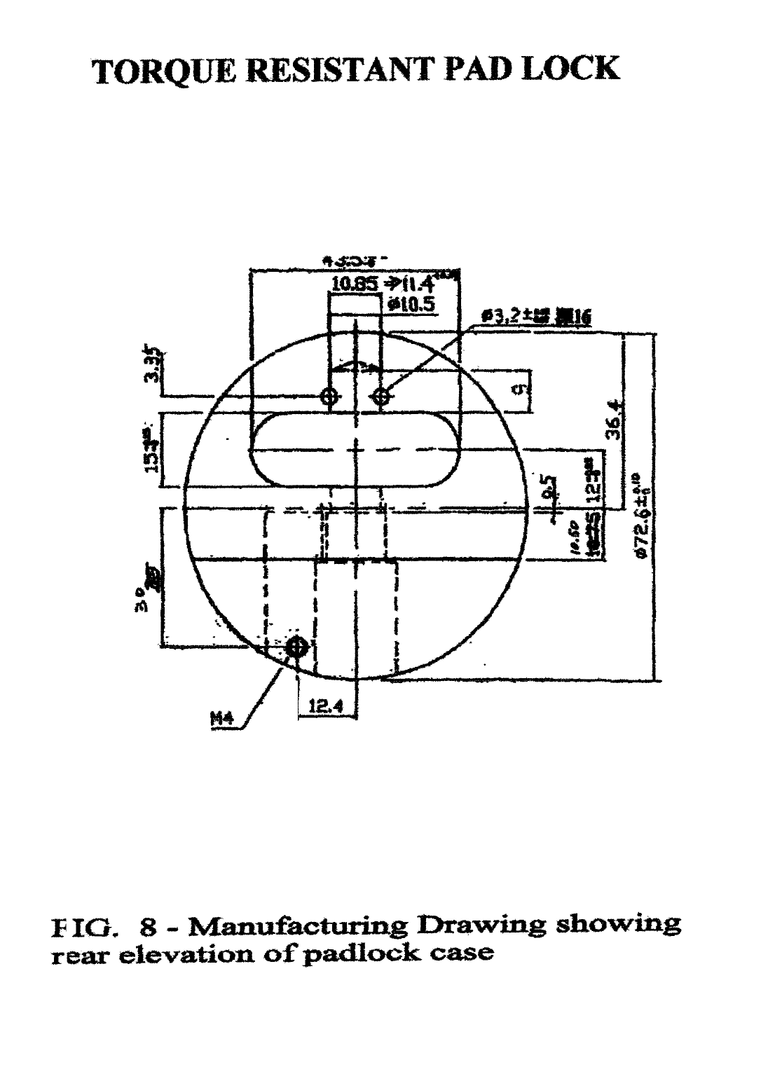

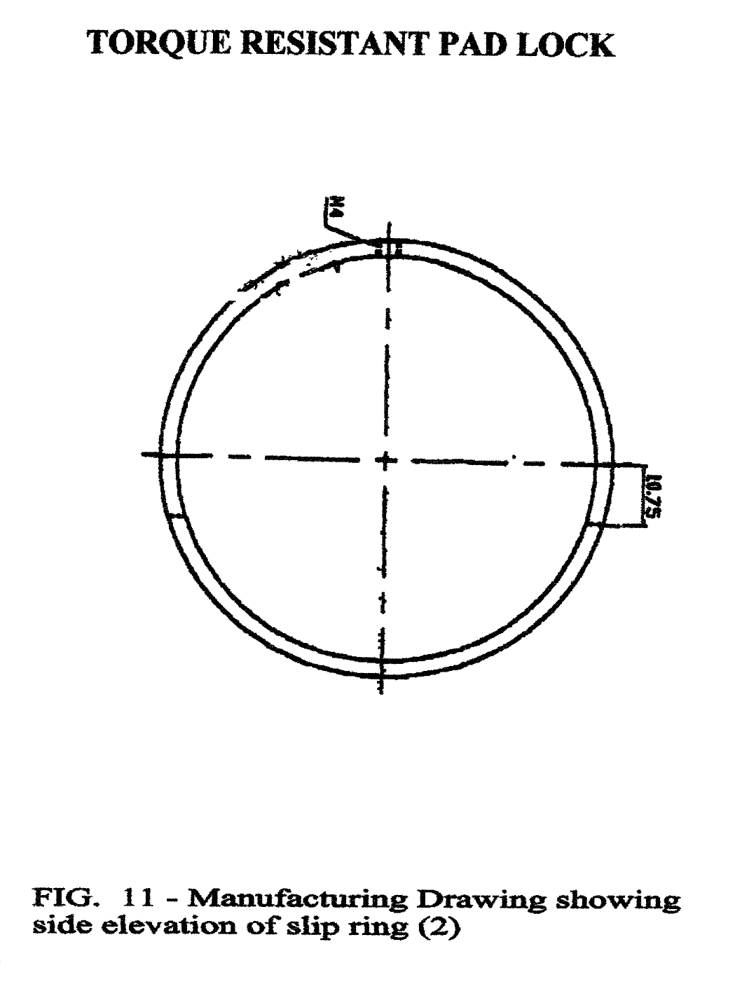

FIGS. 8, 9, 10 and 11 respectively show manufacturer's drawings of the bottom elevation of the unibody padlock case with groove (7) clearly indicated and means to prevent the slip ring from extending beyond the front of the unibody case, the side elevation of the slip ring, the bottom elevation of the slip ring (2) and the side elevation of slip ring (2).

Athough the best mode contemplated for carrying out the present invention has been herein shown and described, it will be apparent that modifications and variations may be made without departing from what is regarded to be the subject matter of the invention.

### DETAILED DESCRIPTION OF THE INVENTION

The invention is an improvement to a padlock and casing originally manufactured by the American Lock Company (“American”) and sold as a Series 2000 lock. That lock was an improvement over a Lippisch lock, U.S. Pat. No. 3,835675. The American lock consisted of a removable chambered, covered plug, key lock encased in a unibody metal cover and circular in shape. The single, straight shackle was protected from the front and the sides by the metal casing. The back of the casing had a semicircular cut out which exposed the shackle from the back to allow the shackle to affix to hasps placed on the device being protected. In the typical application, the padlock was placed on a vending machine with the back of the lock abutting the vending machine. The vending machine would thus provide protection from attack to the rear of the lock. However, the lock suffered from two problems which made it much less secure than the current invention. The lock was subject to attack from torquing moment, as applied via a pipe wrench. When applying torquing moment, sufficient force could be applied to either break the shackle of the lock or, more often, break the hasps to which the lock was attached. In either event, the object intended to be secured by the lock, was no longer secure. Additionally, the lock could be broken by drilling through the face of the unibody case and into the screws holding the housing which secures the head of the shackle when the shackle is in a locked position.

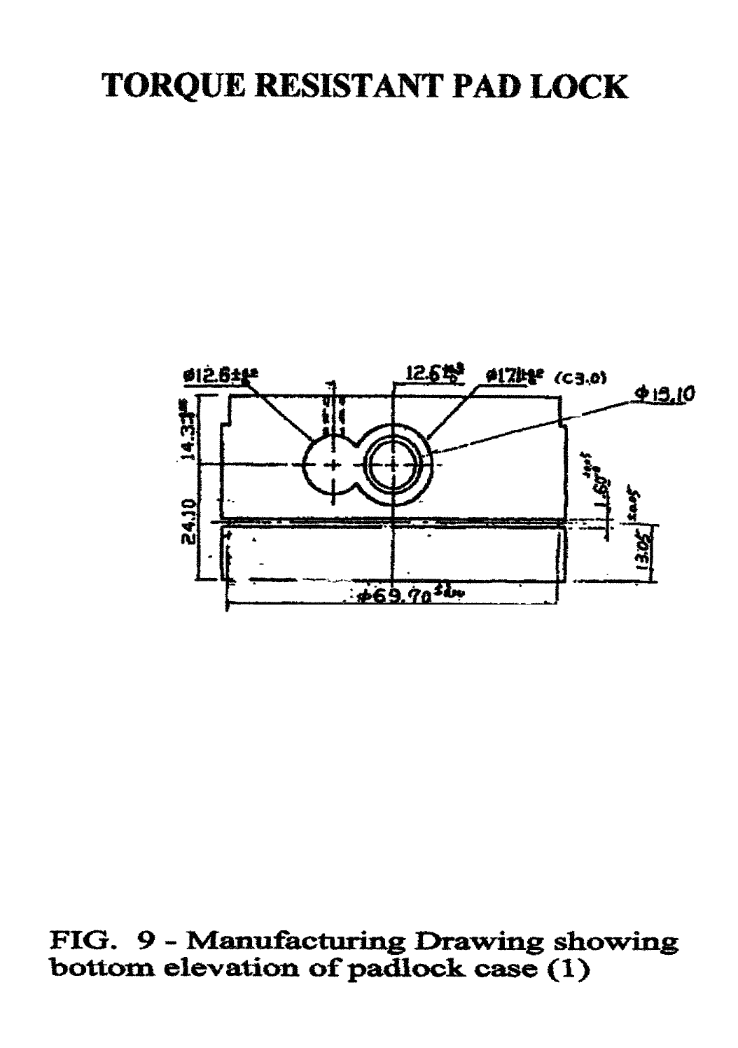

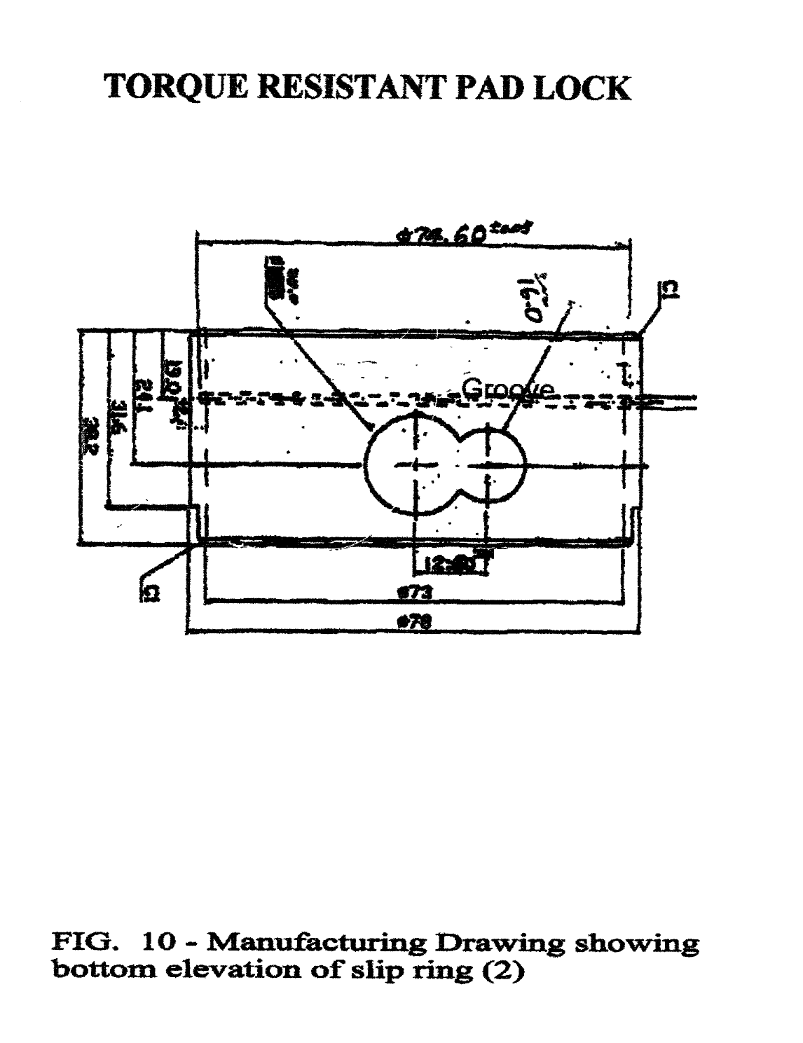

The improvement to the American lock prevents the lock or hasps from being broken by the use of torque as can be applied by an instrument such as a pipe wrench. In the improvement, a lock and casing are designed as above. However, a slip ring (2) is attached on the outside wall of the casing by sliding said slip ring onto the unibody lock casing (1) from the back, as shown in FIG. 6. The slip ring has a built-up portion in its inside wall, as shown in FIG. 9 and the lock casing (1) has a built up portion on its outer wall, as shown in FIG. 10, such that slip ring is prevented from sliding either on to, or off of, the casing from the front. Said slip ring can only be attached around the lock casing by sliding it from the back of the casing and over its outside wall as shown in FIG. 6. Said slip ring is prevent from moving in either a clockwise or counter clockwise manner by the use of a device (3) which provides a stable, but breakable, connection between the casing to the slip ring. The best mode contemplated is through the use of a small screw. The device (3) passes through the slip ring and into a groove (4) placed on the outside wall of the lock case. Said groove runs parallel to the front and to the back surfaces of the lock casing as shown in FIG. 9. An additional groove is placed on the inner wall of the slip ring, as shown in FIG. 10. The means used to prevent the rotational movement of the slip ring is of sufficient strength such that said means will break upon the application of sufficient torque to the lock. Upon breaking said device, the slip ring is allowed to freely move in a rotational manner without breaking either the shackle, the lock or the hasps. With the aforesaid improvements to the American lock, the lock is made vastly more secure because it can not be broken by the application of torque.

Additionally, the lock is made more resistant to attack by drilling through the screw assembly, as shown in FIG. 6, of the housing assembly of the shackle head housing (8). The preferred embodiment of said means is to place, in a shaft used to secure a screw, a ball bearing in the end of the shaft closest to the front of the unibody case. Adjacent to the shaft and closer to the back of the case is a roller pin. Adjacent to the roller pin and closer to the back of the case is a set screw.

Having thus described my invention, what I desire to claim and secure by letters of patent is:

1. A protected shackle, changeable key lock padlock comprising a moveably housed (4) key lock encased in a circular, unibody metal case (1) wherein said casing is in the shape of a circular band or drum which completely covers the front and sides of said case and wherein the back of said unibody case contains a cut out (6) exposing a single bar, straight, shackle (5) protruding from the body of said lock housed in the lower portion of said case and vertically upward into a housing (8) contained in the upper portion of said case, the improvement of which comprises:
(a) means for making said lock resistant to the application of torque force comprising a circular, unibody metal case (1) with a lip on the front edge of the case, a hardened material ring or band (2) or the like, means to slide over said body from back to front without going past the front edge of said unibody case, means (3) to affix said ring to said case such as to allow the connection between said case (1) and said ring (2) to break upon the application of sufficient torque moment and grooves (7) running along the entire surface of the outside wall of said case and parallel to the front and back surfaces of said case and along the entire inner surface of said slip ring also parallel to the front and back surfaces of said ring with said means (3) designed such as to allow said connection to stay within said grooves even after said connection is broken; and
(b) means for making said lock resistant to vandalism by securing the shackle head housing (8) to said lock case (1) by means of a fastening assembly which provides resistance to drilling by allowing a drill bit to freely rotate upon initial contact with said assembly without allowing the drill to make further progress into said fastening assembly.
